(19) United States
(12) Patent Application Publication
(10) Pub. No.: US 2022/0290497 A1
(43) Pub. Date: Sep. 15, 2022

(54) PACKABLE LADDER

(71) Applicant: Red Rock Sourcing LLC, Las Vegas, NV (US)

(72) Inventor: Jeffrey A. Daprizio, Las Vegas, NV (US)

(21) Appl. No.: 17/676,021

(22) Filed: Feb. 18, 2022

Related U.S. Application Data
(60) Provisional application No. 63/154,654, filed on Feb. 26, 2021.
(60) Provisional application No. 63/151,500, filed on Feb. 19, 2021.
(60) Provisional application No. 63/151,496, filed on Feb. 19, 2021.

(51) Int. Cl. E06C 1/06; E06C 7/00; E06C 7/08; E06C 7/50

(52) U.S. Cl. CPC E06C 1/06; E06C 7/003; E06C 7/081; E06C 7/505

(57) ABSTRACT

Embodiments of a packable ladder and a method of assembling it are disclosed. The packable ladder includes two mainframe tubes and at least two steps. Each mainframe tube has a curved end and an attachable end opposite to the curved end. Each step is shaped as a disk having a first end portion and a second end portion disposed at opposite ends thereof. Each of the first end portion and the second end portion is configured to be attached to a respective one of the two mainframe tubes. The method has two steps. In the first step, each of two side rails is formed by attaching each of two mainframe tubes to one or more extension frame tubes. In the second step, at least two steps are attached to the two side rails at a first end portion and a second end portion of each step.

### CROSS-REFERENCE TO RELATED APPLICATIONS

This application claims priority from and benefit of (i) U.S. Provisional Application No. 63/151,496, titled “A Packable Trampoline Ladder,” and filed on Feb. 19, 2021, (ii) U.S. Provisional Application No. 63/151,500, titled “Steps for a Packable Trampoline Ladder,” and filed on Feb. 19, 2021, and (iii) U.S. Provisional Application No. 63/154,654, titled “A Packable Ladder,” and filed on Feb. 26, 2021. The contents of those applications are hereby incorporated by reference in their entirety.

### FIELD OF THE INVENTION

The present invention relates generally to ladders, and, more particularly, to a packable ladder for a variety of uses.

### BACKGROUND OF THE INVENTION

Trampolines are typically positioned at least several feet above ground and therefore, require a relatively long ladder for users to climb thereon. Known ladders are difficult to fit in a compact package because they occupy a lot of space. Accordingly, it is desirable to have a ladder for climbing trampolines that can be packaged compactly, maximize safety and minimize risk of injury from a fall or misstep while climbing.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a packable ladder includes two main frame tubes and at least two steps. Each main frame tube has a curved end and an attachable end opposite to the curved end. Each step is shaped as a disk having a first end portion and a second end portion disposed at opposite ends thereof. Each of the first end portion and the second end portion is configured to be attached to a respective one of the two main frame tubes.

According to certain aspects of the present disclosure, a method of assembling a packable ladder includes two steps. In the first step, each of two side rails is formed by attaching each of two main frame tubes to one or more extension frame tubes. In the second step, at least two steps are attached to the two side rails at a first end portion and a second end portion of each step.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a front perspective view of a packable ladder, according to certain aspects of the present disclosure.

FIG. 2 is a front perspective view of a step of the packable ladder of FIG. 1, according to certain aspects of the present disclosure.

FIG. 3A is a top view of the step of the packable ladder of FIG. 1, according to certain aspects of the present disclosure.

FIG. 3B is a bottom view of the step of the packable ladder of FIG. 1, according to certain aspects of the present disclosure.

FIG. 4A is a front view of the step of the packable ladder of FIG. 1, according to certain aspects of the present disclosure.

FIG. 4B is a rear view of the step of the packable ladder of FIG. 1, according to certain aspects of the present disclosure.

FIG. 5 is a side view of the step of the packable ladder of FIG. 1, according to certain aspects of the present disclosure.

FIG. 6 is an exploded view of two side rails of the packable ladder of FIG. 1, according to certain aspects of the present disclosure.

FIG. 7 is a perspective view (with an additional insets) of assembling the packable ladder of FIG. 1, according to certain aspects of the present disclosure.

FIG. 8 is a block diagram of a method of assembling the packable ladder of FIG. 1, according to certain aspects of the present disclosure.

The present disclosure is susceptible to various modifications and alternative forms, and some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

Embodiments of the disclosure are directed to a packable ladder. The packable ladder includes two side rails, each of which is formed by a main frame tube attached to one or more extension frame tubes. Each of two or more steps are attached to the two side rails on opposite ends. Having two or more pieces enables the side rails to become foldable and thus, packable such that the ladder can be packaged compactly. In different embodiments, the ladder may have two steps, three steps, four steps, or five steps that can be easily coupled and decoupled to the two side rails, thereby further enhancing portability and packability of the ladder. Further, the main frame tube has a curved end that can enable the ladder to be hooked onto various structures and surfaces, thus making it universally usable.

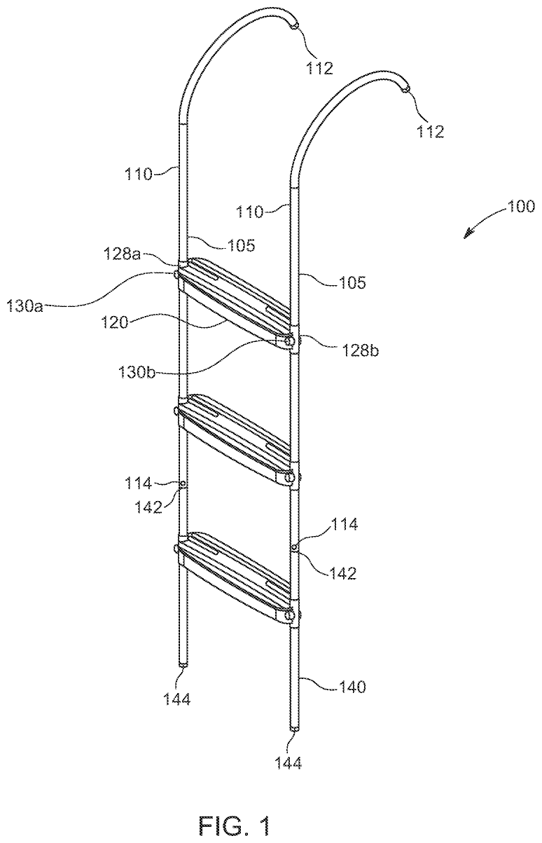

Referring to the figures, FIG. 1 is a front perspective view of a packable ladder 100 in assembled form. An installation kit for the packable ladder 100 has a number of components that can be easily put together to form the packable ladder 100. These components include main frame tubes 110, extension frame tubes 140, steps 120, fasteners, nuts, and tools for assembly. The main frame tubes 110 and the extension frame tubes 140 can be connected end-to-end to form side rails 105 that are then attached to the steps 120 to form the packable ladder 100. In some embodiments, the main frame tubes 110 include curved ends 112 that are designed to have a shape such that the packable ladder 100 can be secured to an object such as a trampoline or a wall. For example, as shown in the non-limiting embodiment of FIG. 1, the main frame tubes 110 are cane-shaped and the curved ends 112 of the two side rails 105 can be hooked into an aperture, and/or around a beam, and/or onto a surface. In other embodiments, the main frame tubes can have a square or flat platform end that can rest on a wall.

The packable ladder 100 includes two main frame tubes 110. Each of the main frame tubes 110 can be attached or connected to one or more extension frame tubes 140 to form each of two side rails 105 of the packable ladder 100. In different embodiments, more than one extension frame tubes 140 (e.g., two extension frame tubes 140, three extension frame tubes 140, etc.) may be attached end-to-end to the main frame tube 110 to form each of the two side rails 105 of the packable ladder 100. In such embodiments, the installation kit for the packable ladder 100 can include the additional extension frame tubes 140.

In the example depicted in FIG. 1, the packable ladder 100 has three steps 120 that are located at a fixed distance from one another. Each step has through-holes 130a, 130b in respective cylindrical apertures 128a, 128b, at opposite ends for coupling each of the three steps 120 to the two side rails 105. The packable ladder 100 can be of any suitable size. For example, in one embodiment, the packable ladder 100 is between about two feet and about six feet in height. In different embodiments, the packable ladder 100 may have two steps, three steps, four steps, or five steps. The steps can be of any suitable size. For example, in one embodiment, the steps are about a foot in length between the opposite ends thereof.

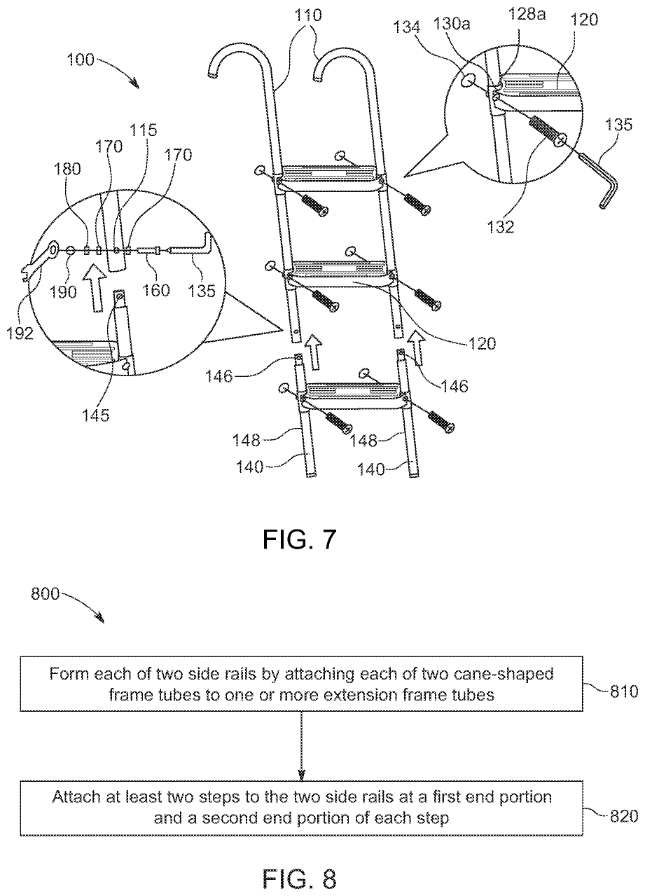

As shown in FIG. 1, each main frame tube 110 includes a curved end 112 and an attachable end 114 opposite to the curved end 112. The main frame tube 110 has holes 115 (FIG. 7) at opposite ends of a perimetric surface of the main frame tube 110 adjacent to the attachable end 114. In some embodiments, each main frame tube 110 is made from a galvanized and powder-coated steel that is weather-resistant and rust-resistant; however, it is contemplated that other suitable materials having weather-resistant and rust-resistant properties may also be used.

Each extension frame tube 140 has a first end 142 that connects to the main frame tube 110 at the attachable end 114, and a second end 144 opposite to the first end 142. In some embodiments, the second end 144 may be connected to another extension frame tube 140. In other embodiments, the second end 144 may remain unconnected. Each extension frame tube 140 has a protruding portion 146 (FIG. 6) and a body portion 148 (FIG. 6) connected to the protruding portion 146. The protruding portion 146 is adjacent to the first end 142, while the body portion 148 is adjacent to the second end 144. The protruding portion 146 has a smaller cross-sectional perimeter than the body portion 148 and the main frame tube 110. The protruding portion has holes 145 (FIG. 7) at opposite ends of a perimetric surface of the protruding portion 146 adjacent to the first end 142. In some embodiments, each extension frame tube 140 is made from a galvanized and powder-coated steel that is weather-resistant and rust-resistant; however, it is contemplated that other materials having weather-resistant and rust-resistant properties may also be used.

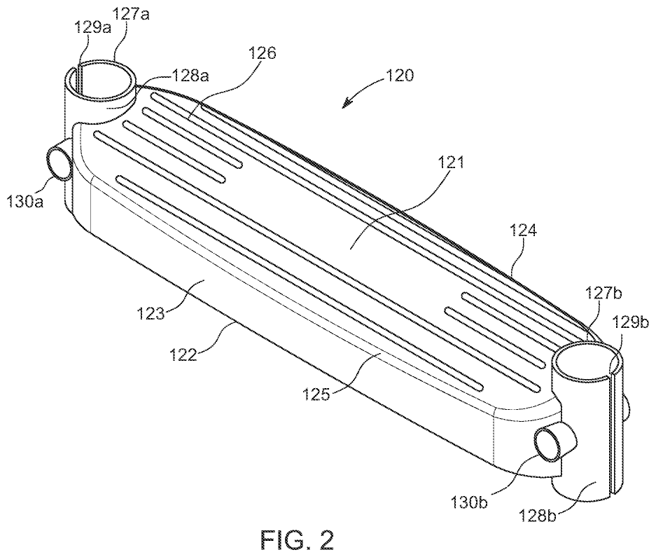

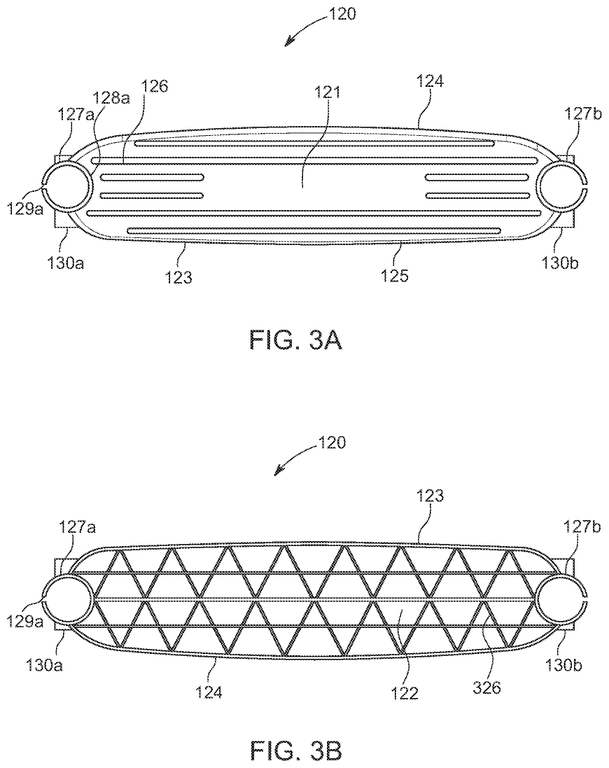

In one embodiment, each step 120 of the packable ladder 100 has distinct features and ornamental design, as disclosed in U.S. Design patent application Ser. No. 29/776,986 filed Apr. 1, 2021, and titled, ‘Steps for a Packable Ladder’, the contents and features of which are hereby incorporated by reference in their entirety. FIG. 2 is a front perspective view of the step 120 of the packable ladder 100, while FIGS. 3A-3B show a top view and a bottom view of the step 120 respectively. The step 120 is shaped as a disk having a closed geometric shape, such as a circle, an ellipse, a square, a pentagon, a hexagon, a heptagon, an octagon, a nonagon, a decagon, etc. While in some embodiments as shown in FIGS. 1-2, the step 120 is a single piece, in other embodiment, the step 120 may be formed from multiple pieces. In some embodiments, each step 120 is made from a high-density polyethylene (HDPE) material, also known as heavy-duty plastic; however, it is contemplated that other suitable materials similar properties may also be used. In some embodiments, each step 120 has a bright fluorescent color for enhanced visibility, such that the packable ladder 100 can be easily spotted in the dark. Further, in some embodiments, each step 120 may have ultra-violet (UV) resistant properties.

The step 120 has a top surface 121 and a bottom space 122 between a front side 123 and a rear side 124. In the example depicted in FIGS. 2 and 3A-3B, the bottom space 122 is hollow. In such embodiments, the bottom space 122 under the top surface 121 may be reinforced with densely-packed structural elements 326 that are arranged to provide additional structural stability and balance, though this is not necessary (i.e., the bottom space 122 may be empty). Regardless of the design of the bottom space 122, each step 120 can distribute weight of human feet evenly. This allows the packable ladder 100 to withstand weights of up to 250 pounds. In some embodiments, the top surface 121 has a chamfered edge 125 around a perimeter thereof. Additionally, in some embodiments, the top surface 121 has anti-slip properties, for example, by having a textured surface, a ribbed surface, and/or a uniform or non-uniform padding layer that human feet can grip on when stepped on during climbing. In the embodiment shown in FIGS. 2, 3A-3B, the top surface 121 includes ribs 126 to provide additional grip for human feet. In some embodiments, the top surface 121 may be sloped between the rear side 124 and the front side 123.

The step 120 has a first end portion 127a and a second end portion 127b opposite to the first end portion 127a. The first end portion 127a and the second end portion 127b are each configured to be attached to the main frame tube 110, the extension frame tube 140, or the side rail 105 formed by connecting the main frame tube 110 to the extension frame tube 140. In some embodiments, each of the first end portion 127a and the second end portion 127b is attached to each of the two side rails 105 at a location where the extension frame tube 140 is attached to the main frame tube 110.

In some embodiments, the steps 120 are attached to the main frame tube 110, the extension frame tube 140, or the side rail 105. In such embodiments, the first end portion 127a has a cylindrical aperture 128a with a slit 129a for accommodating the mainframe tube 110, the extension frame tube 140, or the side rail 105 formed by connecting the main frame tube 110 to the extension frame tube 140. The cylindrical aperture 128a has a through-hole 130a, wherein a fastener can be inserted to attach the first end portion 127a to the main frame tube 110, the extension frame tube 140, or the side rail 105. Similarly, the second end portion 127b has a cylindrical aperture 128b with a slit 129b for accommodating the main frame tube 110, the extension frame tube 140, or the side rail 105. The cylindrical aperture 128b has a through-hole 130b, wherein a fastener can be inserted to attach the second end portion 127b to the main frame tube 110, the extension frame tube 140, or the side rail 105.

In some embodiments, each of the cylindrical apertures 128a, 128b have a first longitudinal axis generally perpendicular to each step 120. In other embodiments, the first longitudinal axis of the cylindrical apertures 128a, 128b may be angled with respect to each step 120. Further, in some embodiments, each of the through-holes 130a, 130b has a second longitudinal axis that is generally perpendicular to the first longitudinal axis of the respective cylindrical apertures 128a, 128b. In other embodiments, the second longitudinal axis may be angled with respect to the respective first longitudinal axis of the cylindrical apertures 128a, 128b.

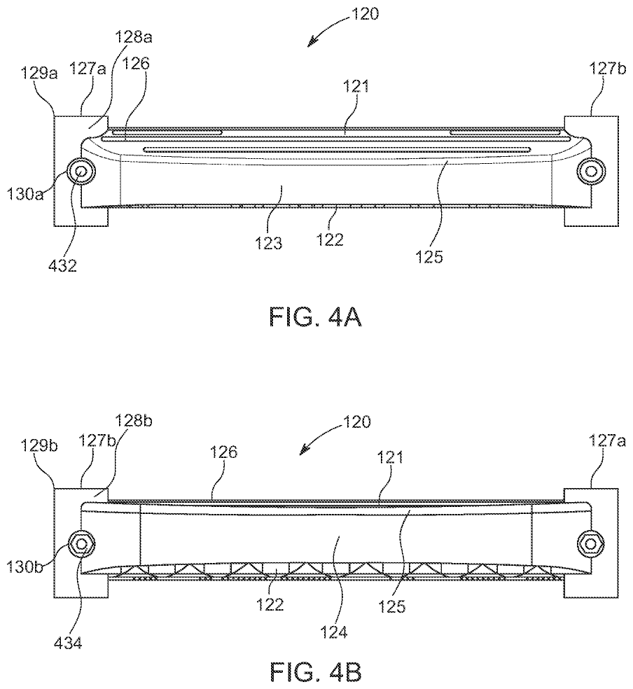

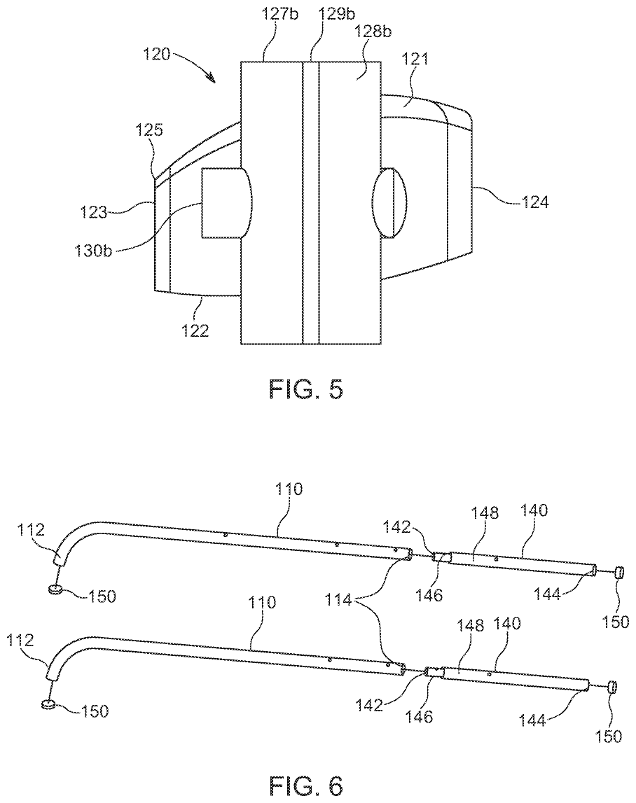

FIGS. 4A-4B are a front view and a rear view, respectively, of the step 120 of the packable ladder 100, while FIG. 5 is a side view of the step 120. As shown in FIGS. 4A-4B, the step 120 is configured to be attached to the side rails 105 with a fastener 432 (FIG. 4A) through the cylindrical apertures 128a, 128b on the front side 123 of the step 120. The fastener 432 can be tightened with a nut 434 (FIG. 4B) on the rear side 124 of the step 120.

FIG. 6 is an exploded view of two side rails 105 of the packable ladder 100 in unassembled form, while FIG. 7 is a perspective view (with an additional insets) of assembling the packable ladder 100. A method 800 of assembling the packable ladder 100, shown in the block diagram of FIG. 8, can be described with respect to FIGS. 6-7.

In block 810, the method 800 is performed by forming each of two side rails by attaching each of two main frame tubes to one or more extension frame tubes. In some embodiments, this involves inserting a protruding portion of each of two extension frame tubes into an attachable end of each of the two main frame tubes, wherein the protruding portion has a smaller cross-sectional perimeter than each of the two main frame tubes. As shown in FIG. 6, the first end 142 of the protruding portion 146 of the extension frame tube 140 is placed adjacent to the attachable end 114 of the main frame tube 110. The protruding portion 146 is inserted into the main frame tube 110.

Next, holes at opposite ends along respective perimetric surfaces of the protruding portion and each of the two main frame tubes are aligned. As shown in the left inset of FIG. 7, the holes 115 at opposite ends of the perimetric surface of the main frame tube 110 adjacent to the attachable end 114 are aligned with the holes 145 at opposite ends of the perimetric surface of the protruding portion 146 adjacent to the first end 142.

Then, each of the two extension frame tubes is attached to the respective one of the two main frame tubes using a fastener (e.g., a screw, a spring-loaded nut). In the example depicted in the left inset of FIG. 7, a fastener 160 (e.g., 35 mm long bolt) is passed through the holes 115 and 145 as well as arc washers 170 and a spring washer 180 before a nut 190 (e.g., cap nut) is used to secure the fastener 160. A The extension frame tube 140 is thus connected to the main frame tube 110. An Allen wrench 135 and an adjustable wrench 192 may be used to tighten the fastener 160 with the nut 190. Thus each of the two side rails 105 are formed. In some embodiments, after the side rails 105 are formed, the curved ends 112 of the main frame tubes 110 and the second ends 144 of the extension frame tubes 140 are plugged using inner caps 150.

In some embodiments, each of the side rails 105 may be formed simply with the main frame tube 110, without attaching the extension frame tube 140. In such embodiments, the curved ends 112 as well as the attachable ends 114 of the main frame tubes 110 are plugged using the inner caps 150.

In block 820, the method 800 is performed by attaching at least two steps to the two side rails at a first end portion and a second end portion of each step. In some embodiments, the steps are attached to each of the two side rails at a location where each of the two extension frame tubes is attached to the respective one of the two main frame tubes.

In some embodiments, attaching the steps to the side rails involves inserting each of the two side rails through a cylindrical aperture at a respective one of the first end portion and the second end portion of each step respectively. As shown in the right inset of FIG. 7, each of the two side rails 105, once assembled, are inserted through the cylindrical apertures 128a, 128b at the first end portion 127a and the second end portion 127b, respectively, of each step 120.

Next, each of two fasteners is inserted through a through-hole in the cylindrical aperture at the respective one of the first end portion and the second end portion. As shown in the right inset of FIG. 7, each of two fasteners 132 is inserted through each of the cylindrical apertures 128a, 128b and passed through each of two nuts 134 located at the rear end thereof.

Then, each of the two fasteners is tightened against a nut to attach each of the two side rails to the respective one of the first end portion and the second end portion. As shown in the right inset of FIG. 7, each of the two fasteners 132 and the respective nut 134 are tightened using the Allen wrench 135. Thus, each step 120 is coupled to the two side rails 105, thereby completing assembly of the packable ladder 100.

In some embodiments, the method 800 further includes providing additional grip for human feet on a top surface of each of the at least two steps by a textured surface, and/or a ribbed surface, and/or a padding layer.

Embodiments of the packable ladder described herein can be advantageously used in a variety of settings such as in stores, warehouses, offices, houses, swimming pools, fire escape, trampolines (e.g., a trampoline having a height between about 3 feet and about 20 feet), and anywhere a ladder having a height between about two feet and about six feet may be needed. In some embodiments, the curved ends of the side rails can be hooked around one or more surfaces of steel beams, metallic racks, metal tubings, wooden frames, etc., having cross-sections that are shaped as a circle or any polygon. In other embodiments, the curved ends of the side rails can be hooked into apertures of a structure or frame or rope and coupled thereto for climbing. The steps of the packable ladder are designed to have anti-slip property and can evenly distribute weight of human feet.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A packable ladder comprising:
two main frame tubes, each main frame tube having a curved end and an attachable end opposite to the curved end; and
at least two steps, wherein each step is shaped as a disk having a first end portion and a second end portion disposed at opposite ends thereof, and wherein each of the first end portion and the second end portion is configured to be attached to a respective one of the two main frame tubes.

2. The packable ladder of claim 1, further comprising two extension frame tubes, each extension frame tube configured to be attached to the attachable end of the main frame tube, wherein each extension frame tube has a protruding portion and a body portion, the protruding portion having a smaller cross-sectional perimeter than the body portion and each of the two main frame tubes.

3. The packable ladder of claim 2, wherein each of the two extension frame tubes are configured to be attached to another extension frame tube at an end opposite to an end attached to the main frame tube.

4. The packable ladder of claim 1, wherein the first end portion and the second end portion of each step comprises a cylindrical aperture for accommodating each of the two main frame tubes therethrough.

5. The packable ladder of claim 4, wherein the cylindrical aperture has a first longitudinal axis generally perpendicular to each step.

6. The packable ladder of claim 4, wherein the cylindrical aperture at each of the first end portion and the second end portion further comprises a through-hole for attaching a respective one of the two main frame tubes.

7. The packable ladder of claim 5, wherein the cylindrical aperture at each of the first end portion and the second end portion further comprises a through-hole having a second longitudinal axis that is generally perpendicular to the first longitudinal axis of the cylindrical aperture.

8. The packable ladder of claim 1, wherein the curved end of each of the two main frame tubes are shaped to be hooked (i) into an aperture, (ii) around a beam, (iii) onto a surface, or (iv) any combination thereof.

9. The packable ladder of claim 2, wherein the two main frame tubes and the two extension frame tubes are formed from a galvanized and powder-coated steel.

10. The packable ladder of claim 1, wherein each step has a top surface and a bottom space under the top surface.

11. The packable ladder of claim 1, wherein each step is formed from a high-density polyethylene (HDPE) material.

12. The packable ladder of claim 10, wherein the top surface has a chamfered edge around a perimeter thereof.

13. The packable ladder of claim 10, wherein the top surface is sloped from a rear side to a front side thereof.

14. The packable ladder of claim 10, wherein the top surface further comprises (i) a textured surface, (ii) a ribbed surface, (iii) a padding layer, or (iv) any combination thereof, for providing additional grip to human feet.

15. The packable ladder of claim 1, wherein each step has a bright fluorescent color for enhanced visibility.

16. A method of assembling a packable ladder, the method comprising:
forming each of two side rails by attaching each of two main frame tubes to one or more extension frame tubes; and
attaching at least two steps to the two side rails at a first end portion and a second end portion of each step.

17. The method of claim 16, wherein the forming each of two side rails further comprises:
inserting a protruding portion of each of two extension frame tubes into an attachable end of each of the two main frame tubes, the protruding portion having a smaller cross-sectional perimeter than each of the two main frame tubes;
aligning holes at opposite ends along respective perimetric surfaces of the protruding portion and each of the two main frame tubes; and
attaching each of the two extension frame tubes to the respective one of the two main frame tubes using a fastener and a nut.

18. The method of claim 16, wherein the attaching at least two steps to the two side rails further comprises:
inserting each of the two side rails through a cylindrical aperture at a respective one of the first end portion and the second end portion of each step respectively;
inserting each of two fasteners through a through-hole in the cylindrical aperture at the respective one of the first end portion and the second end portion; and
tightening each of the two fasteners against a nut to attach each of the two side rails to the respective one of the first end portion and the second end portion.

19. The method of claim 16, wherein the at least two steps are attached to each of the two side rails at a location where each of at least two extension frame tubes is attached to the respective one of the two mainframe tubes.

20. The method of claim 16, further comprising providing additional grip for human feet on a top surface of each of the at least two steps by (i) a textured surface, (ii) a ribbed surface, (iii) a padding layer, or (iv) any combination thereof.
